(19) United States
(12) Patent Application Publication
(10) Pub. No.: US 2013/0169150 A1
(43) Pub. Date: Jul. 4, 2013

(54) INCREASED WEIGHT OF EMISSION MATERIALS ON FLUORESCENT LAMP ELECTRODES

(71) Applicants: István Deme, Budapest (HU); Miklós Budai, Budapest (HU); Imre Dékány, Szeged (HU); Adam Juhasz, Szeged (HU)

(72) Inventors: István Deme, Budapest (HU); Miklós Budai, Budapest (HU); Imre Dékány, Szeged (HU); Adam Juhasz, Szeged (HU)

(21) Appl. No.: 13/339,419

(22) Filed: Dec. 29, 2011

(51) Int. Cl. H01J 61/20; B05D 3/00; H01J 9/38; B05D 5/06

(52) U.S. Cl. 313/623; 427/64; 29/592.1

(57) ABSTRACT

A fluorescent lamp has increased weight of emission mix material on the metal coils forming the electrodes. The coating layer of emission mix material includes in the range of 70 weight % to 85 weight % alkaline earth carbonate content. The coating layer of emission mix material has a particle size distribution by volume with two maxima, and one of the maxima is at a particle size that is no more than half and up to one tenth smaller than of the particle size of the other maximum. The smaller of the two maxima constitutes 10 weight % to 40 weight % of the alkaline earth carbonates in the coating layer of emission mix material. A method for making fluorescent lamp includes the step of installing at least one electrode coated with an emission mix material including more than 70 weight % alkaline earth carbonate content.

### FIELD OF THE INVENTION

The present invention generally involves fluorescent lamps and in particular the coating of the electrodes for emissive electrodes of a fluorescent lamp.

### BACKGROUND

A fluorescent lamp comprises electrodes in a tube coated internally with phosphor and containing mercury vapor. Passing electricity through the lamp's electrodes excites the mercury to produce short-wave ultraviolet light (mostly at wavelengths of 253.7 nm and 185 nm), which then causes the phosphor to fluoresce, making visible light. The electrodes typically are formed of tungsten coils that have been coated with emission material that has a low thermionic emission temperature and thus emits electrons at relatively low temperatures. Electricity passing through the coils generates enough heat to attain the thermionic emission temperature of the emission material, which continuously decreases during burning.

The coating of the coils with the emission material is conventionally carried out by submerging the coils in a coating suspension of alkaline earth carbonates (which may optionally comprise other components such as zirconia). The coils so coated with the suspension are dried. By resistive heating of the coated coils, the organic ingredients of the suspension are evaporated and pyrolyzed, and the carbon dioxide is removed from the inorganic ingredients of the suspension, which thus are converted to alkaline earth oxides. The amount of alkaline earth oxides remaining on the coil depends on the concentration of the alkaline earth carbonates in the coating suspension. However, there is a limit on the concentration of the alkaline earth carbonates because the coating processes require the suspensions to possess a suitable range of fluidity (viscosity).

### BRIEF DESCRIPTION OF THE INVENTION

Aspects and advantages of the invention are set forth below in the following description, or may be obvious from the description, or may be learned through practice of the invention.

One embodiment of the invention is directed to a method for making a light source that includes a substantially transparent envelope having an inner surface coated with a layer including a phosphor composition. The method comprises installing in the envelope at least one electrode coated with an emission mix material, wherein the at least one electrode coated with an emission mix-material has been prepared by coating an electrode with a suspension comprising more than about 70 weight % alkaline earth carbonate content. The method further comprises evacuating the envelope; and adding into the evacuated envelope and confining within the envelope, a first amount of mercury and a second amount of an inert gas to produce the light source.

Another embodiment of the invention is directed to a mercury vapor discharge fluorescent lamp, comprising a sealed, light-transmissive envelope having an inner surface defining an interior volume of the envelope; an electrode structure disposed within the interior volume of the envelope and configured for providing a discharge within the interior volume of the envelope; and a fill gas comprising mercury and an inert gas sealed inside the envelope. The electrode structure comprises a coating layer of emission mix material which has been prepared by coating an electrode with a suspension comprising more than about 70 weight % alkaline earth carbonate content.

A further embodiment of the invention is directed to a method for making an electrode coated with an emission mix material. The method comprises coating an electrode with a suspension comprising more than about 70 weight % alkaline earth carbonate content to form a coated electrode, optionally drying the coated electrode to form a dried electrode, and activating the dried electrode to form an electrode coated with an emission mix material.

An aspect of the present invention includes a method by which the weight of emission mix material on the coils of fluorescent lamps can be increased beyond the weight that is deposited on the coils using conventional techniques. The method may include applying to the tungsten coils intended for a fluorescent lamp a coating suspension of 70 to 85 weight % alkaline earth carbonate content having 10 to 40 weight % of the carbonates having a modal particle size 2 to 10 times smaller than the usual 3 micrometer to 10 micrometer range of modal particle size of the distribution by volume for the carbonates. The particle size distribution by volume of the resultant carbonate mixture thus can have two maxima (bimodal or bidisperse), one falling into the usual size range while the other is 2 to 10 times smaller. However, as one way to ensure bimodality, by ensuring that the smaller sized fraction does not appear as a mere shoulder on the original distribution of the coarser fraction, the distributions of the two fractions should not overlap too much. In this way the particle size distribution by volume of the resultant carbonate mixture can be made wider than the size distribution of the original (coarse) suspension. By using this modified suspension for the coating of the tungsten coils, the same conventional process can be employed to obtain a higher weight of emission mix material on the coil and thus longer lamp life than with the conventional (monomodal, coarse) carbonate suspension. Lamp life thus can be increased approximately in proportion to the increase of the weight of the emission material on the coils. Control of particle size normally can be done either by choosing the synthesis method appropriate for yielding the desired particle size, or by milling a coarse suspension, or by fractionation of a suspension having a wide distribution of particle sizes. Alternatively, the required mixing ratio of three alkaline earth carbonates can be achieved by blending two—one coarse and one finer sized—fractions of different composition.

In another aspect of the present invention, tungsten coils carrying increased weight of emission material are provided for fluorescent lamps, and the required mixing ratio of three alkaline earth carbonates can be achieved by blending two—one coarse and one finer sized—fractions of different composition.

In another aspect of the present invention, tungsten coils carrying increased weight of emission material are provided for fluorescent lamps.

In a further aspect of the present invention, fluorescent lamps are provided having increased weight of emission material on the metal coils forming the electrodes.

An aspect of the method of the present invention also may include applying to the tungsten coils intended for a fluorescent lamp a coating suspension of 70 weight % to 85 weight % alkaline earth carbonate content with at least 10 weight % of the carbonates having a modal particle size in the 0.3 to 5.0 micrometer range.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 shows a first preferred embodiment of a mercury vapor discharge fluorescent lamp according to the present invention with portions cut away and portions shown in cross section;

FIG. 2 schematically shows an enlarged view of the portion of FIG. 1 encircled by the balloon designated A in FIG. 1;

FIG. 3 schematically shows an enlarged cross sectional view taken in the direction of the arrows designated 3-3 in FIG. 2;

FIG. 4 graphically presents a monomodal distribution of particle sizes in which the horizontal axis denominates the particle size in LOG 10 micrometers;

FIG. 5 graphically presents a monomodal distribution of particle sizes in which the horizontal axis denominates the particle size in LOG 10 micrometers;

FIG. 6 graphically presents a monomodal distribution of particle sizes in which the horizontal axis denominates the particle size in LOG 10 micrometers;

FIG. 7 graphically presents a monomodal distribution of particle sizes in which the horizontal axis denominates the particle size in LOG 10 micrometers;

FIG. 8 graphically presents a bimodal distribution of particle sizes in which the horizontal axis denominates the particle size in LOG 10 micrometers; and

FIG. 9 schematically represents embodiments of the methods of the present invention for making a light source with electrodes that carry extra amounts of emission material.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, a “fluorescent lamp” is any mercury vapor discharge fluorescent lamp as known in the art wherein the means for providing a discharge includes electrodes coated with thermionic material.

Also as used herein, a “T8 lamp” is a fluorescent lamp as known in the art, desirably linear in the shape of a right cylinder, desirably nominally 48 inches in length, and having a nominal outer diameter of 1 inch (eight times ⅛ inch, which is where the “8” in “T8” derives). However, the T8 fluorescent lamp can be nominally 2, 3, 6 or 8 feet long, or some other length. Moreover, the method and apparatus disclosed herein is applicable to other lamp sizes and loadings, ranging from T12 to T4 in diameter, and including compact fluorescent lamp (CFL) types as well.

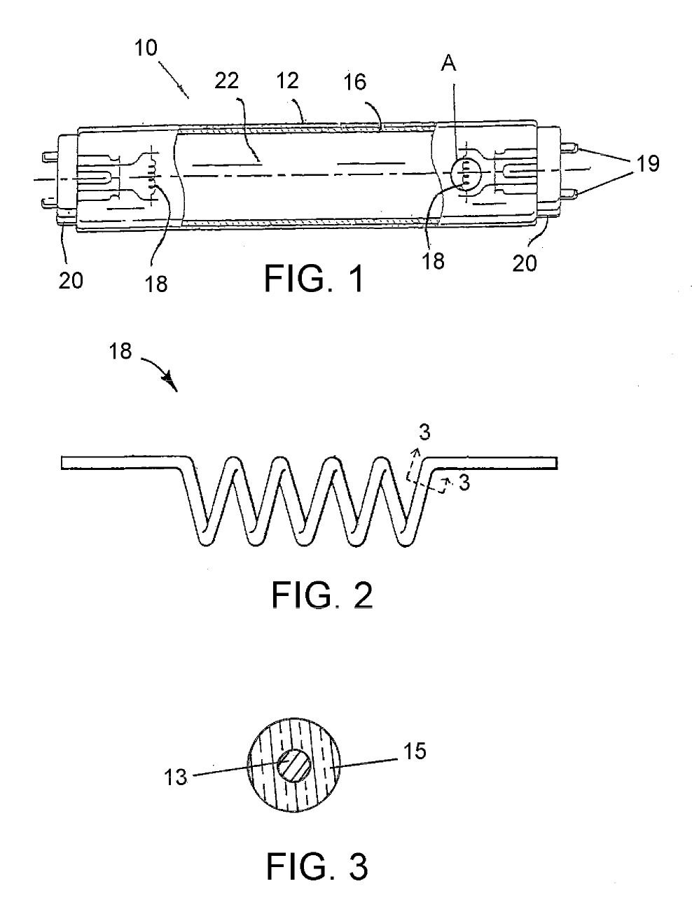

Referring to FIG. 1, a mercury vapor discharge fluorescent lamp 10 according to a first preferred embodiment of the present invention is schematically depicted with portions cut away and portions shown in cross section. Though the lamp 10 in FIG. 1 is linear in the shape of a right cylinder, the invention is not limited to linear lamps and may be applied to fluorescent lamps of any shape. The fluorescent lamp 10 includes a sealed, light-transmissive, hollow glass envelope 12 having an inner surface defining an interior volume of the envelope 12. The glass tube or envelope 12 desirably has a cross-section that is circular when taken normal to the longitudinal axis of the lamp 10. As schematically shown in FIG. 1, the fluorescent lamp 10 has a phosphor composition coating layer 16 that includes a phosphor composition formed on a substantial portion of the envelope 12 and desirably covers essentially the entire inner surface thereof. The phosphor composition coating layer 16 can include one or more distinct layers of material and/or compositions of material.

As schematically shown in FIG. 1, the lamp 10 is hermetically sealed at each of the opposite ends of the glass envelope 12 by a base 20 attached at one of the two spaced apart opposite ends of the glass envelope 12 and another base 20 attached at the other one of the two spaced apart opposite ends of the glass envelope 12. In embodiments of lamps 10 such as that in FIG. 1 wherein the means for providing a discharge within the interior volume of the envelope 12 includes electrodes, an electrode structure 18 desirably is respectively mounted on each of the bases 20. The electrodes 18 are disposed in the hollow interior volume of the envelope 12 and are electrically connected to prongs 19 that extend from the exterior of the bases 20 for electrically connecting the electrodes 18 to a source of electricity. A discharge-sustaining fill gas 22 of mercury and an inert gas is sealed in the hollow interior volume inside the glass tube 12. The inert gas desirably is argon or a mixture of argon and krypton, but could be some other inert gas or mixture of inert gases. The inert gas and a small quantity of mercury vapor provide the low vapor pressure manner of operation. Preferably, in a T8 lamp during operation the mercury vapor has a pressure of around 0.8 Pa.

FIG. 2 depicts an enlarged view of the portion of the electrode structure 18 identified by the balloon designated by the letter A in FIG. 1. As schematically depicted in FIG. 3, which shows an enlarged cross sectional view taken along the lines 3-3 in FIG. 2, the electrode structure 18 desirably is formed by a metal coil 13 that is surrounded by a coating layer of emission material 15 that is annular in definition. The coil 13 desirably is formed of tungsten, and the emission material 15 desirably is formed of alkaline earth carbonates.

TABLE I

| Differential | | | | | |
|---|---|---|---|---|---|
| distribution size | volume | volume | volume | volume | volume |
| log micron | I | II | III | IV | V |
| 0.1 | 0 | 0 | 0 | 0 | 0 |
| 0.2 | 1 | 0 | 0 | 1 | 1 |
| 0.3 | 4 | 0 | 0 | 4 | 4 |
| 0.4 | 1 | 6 | 2 | 3 | 7 |
| 0.5 | 0 | 12 | 14 | 14 | 12 |
| 0.6 | 0 | 18 | 22 | 22 | 18 |
| 0.7 | 0 | 12 | 14 | 14 | 12 |
| 0.8 | 0 | 6 | 2 | 2 | 6 |
| 0.9 | 0 | 0 | 0 | 0 | 0 |
| 1 | 0 | 0 | 0 | 0 | 0 |
| sum | 6 | 54 | 54 | 60 | 60 |

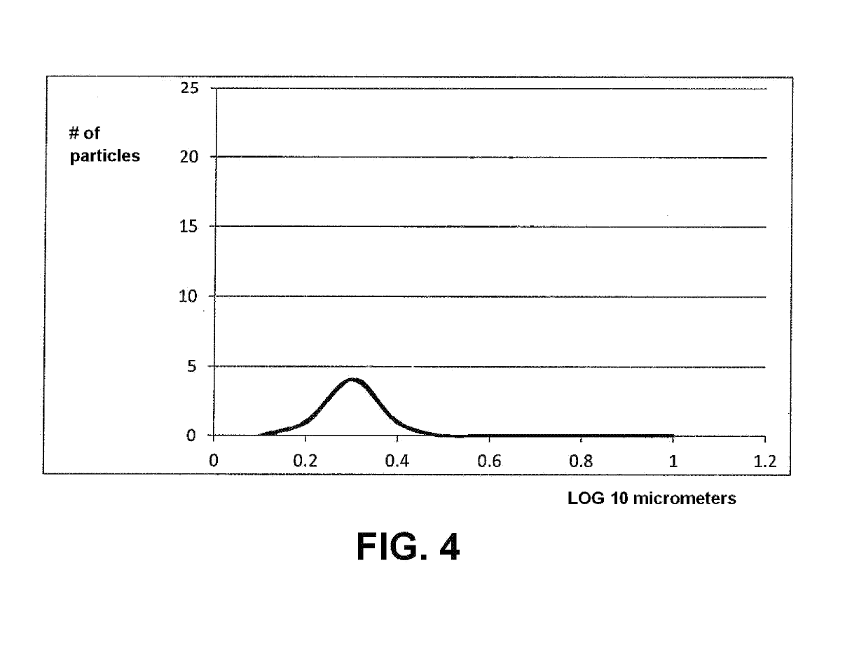

As used herein, in reference to a particle size that characterizes a distribution of particles, the mode is the size of the most probable particle weighted by its volume, and this mode is the size at the peak of the histogram, or the size at the maximum of the differential distribution curve. The size distribution of these powders of alkaline earth carbonates is generally of log-normal type, i.e., the histogram is symmetrical around the mode above a logarithmic horizontal axis, and it is easier to detect the mode value when plotting the size in terms of a LOG 10 horizontal axis. For instance, as illustrated in FIG. 4 for example, in a given distribution of carbonate particles assumed to be spherical in shape, if one adds up the total volume occupied by particles having a diameter in micrometers the LOG 10 of which is 0.3 and that volume exceeds each of the volumes occupied by particles in the distribution having any other diameter (i.e., a LOG 10 micrometer diameter other than 0.3), then the modal size in LOG 10 micrometers of that distribution of carbonate particles assumed to be spherical in shape is 0.3. As an illustration, because Sample I presented in Table I has one gram of particles having a diameter in micrometers the LOG 10 of which is 0.2, one gram of particles having a diameter in micrometers the LOG 10 of which is 0.4, and four grams of particles having a diameter in micrometers the LOG 10 of which is 0.3, this six grams of particles of Sample I has a mode of 0.3 in LOG 10 micrometers.

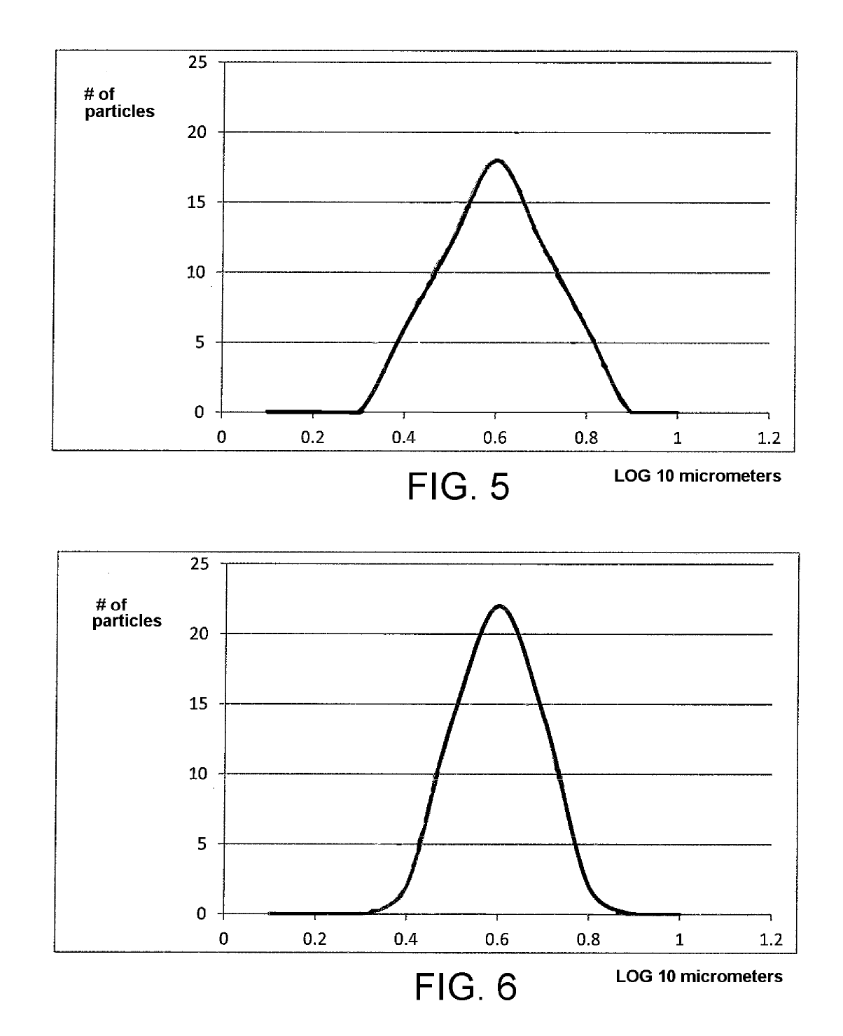

Table I presents a chart of three sample particle distributions and two ways of mixing one of the sample particle distributions with the other two sample particle distributions. Sample I is composed of six grams of particles wherein the modal particle size in LOG 10 micrometers is 0.3 and is graphically presented in FIG. 4. Sample II is composed of fifty-four grams of particles wherein the modal particle size in LOG 10 micrometers is 0.6 and is graphically presented in FIG. 5. Sample III is composed of fifty-four grams of particles wherein the LOG 10 modal particle size is 0.6 and is graphically presented in FIG. 6. Note that the distribution of particles in Sample II differs from the distribution of particles in Sample III.

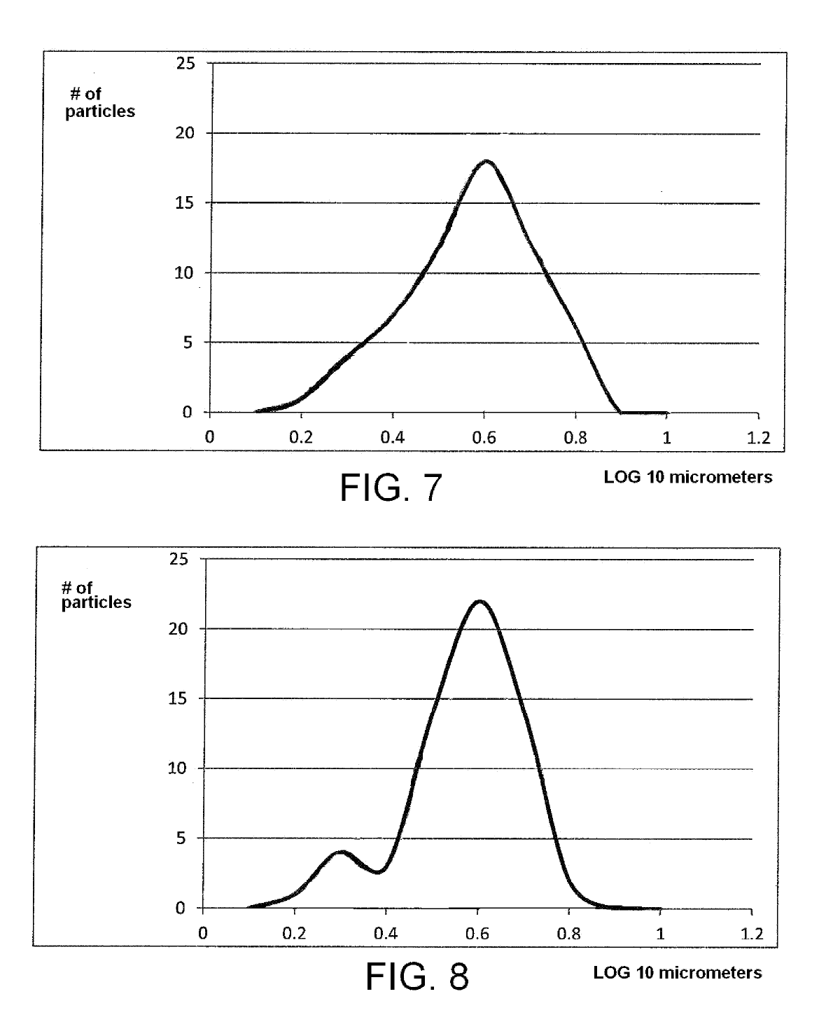

Sample IV represents a mixture of the particles in Sample I with the particles in Sample II and is graphically presented in FIG. 7. Sample V represents a mixture of the particles in Sample I with the particles in Sample III and is graphically presented in FIG. 8. Note that the mixture of the particles in Sample I with the particles in Sample II creates a monomodal distribution in Sample IV wherein the LOG 10 modal particle size is 0.6 as is graphically presented in FIG. 7. However, as is graphically presented in FIG. 8, the mixture of the particles in Sample I with the particles, in Sample III creates a bimodal distribution in Sample V wherein the LOG 10 bimodal particle sizes are both 0.3 and 0.6.

As in each of Samples IV and V, if one provides 60 grams of an emission mix material by combining 6 grams of a distribution of alkaline earth carbonate particles of LOG 10 modal size 0.3 with 54 grams of a distribution of alkaline earth carbonate particles of LOG 10 modal size 0.6, then this emission mix material will have a particle size distribution that is the sum of those of the “parent” distributions. As graphically shown in FIG. 8, this emission mix material (Sample V) can be bimodal if each of the two parent distributions (Samples I and III) is narrow enough, i.e., if the overlapping area of the two parent distributions is not too large.

Conventional suspensions of alkaline earth carbonates that are used to form coatings of emission mix material on conventional electrodes 18 of fluorescent lamps are mono-modal, and the mode of the volume distribution of the particles contained therein falls in the 3 micrometer to 10 micrometer range. In order to maintain a suitable range of fluidity (viscosity) for coating electrodes with such conventional suspensions, the carbonate solids content of the suspension had heretofore been usually limited to no more than 70 weight %.

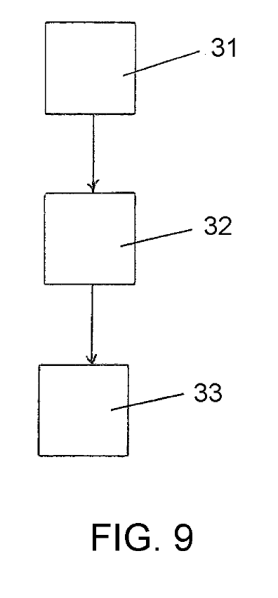

In accordance with embodiments of the present invention, methods are provided for making a light source that includes a substantially transparent, hollow envelope that has an inner surface coated with a layer including a phosphor composition. As schematically represented in FIG. 9, such methods desirably include a step 31 that calls for installing in the envelope 12 an electrode 18 coated with an emission material 15 wherein the coated electrode has been prepared by coating with a suspension including more than 70 weight % alkaline earth carbonate content and desirably as much as 85 weight % alkaline earth carbonate content. Thereafter, the methods desirably call for the step 32 of evacuating the envelope 12. As schematically represented in FIG. 9, once the envelope 12 is evacuated, the methods desirably call for the step 33 of adding into the evacuated envelope 12 and confining within the envelope 12, a gas 22 that includes a first amount of mercury and a second amount of an inert gas to produce the light source.

The electrodes may be coated with an emission mix material by any effective method, including many well known methods. Emission mix may typically be applied to the electrodes as a suspension (e.g., slurry) comprising an inorganic mixture of at least one of barium, strontium and calcium carbonates. The emissive mixture suspension is then coated onto an electrode, such as a cathode of a fluorescent lamp, by a process such as dip coating or other coating processes.

Once applied, the carbonates are dried and then subsequently decomposed during an activation step, to form an active emission mix oxide material. That is, alkaline earth metal carbonates decompose to form alkaline earth metal oxides, which is the active emissive form of the material when in use on the electrode. Activation may be carried out by furnace heating and/or by resistively heating to obtain the emissive mixture formed on the electrode (i.e., the emissive mixture is “activated”).

In a preferred embodiment, the suspension medium comprises a low volatility liquid as a carrier for the carbonates. Typically, it may be evaporated during drying (if water based) or may be decomposed or oxidized to carbon dioxide and water prior to and/or during activation (if organic based). In one embodiment, the suspension medium comprises an organic substance, e.g., polyethylene glycols or glycerin. Alternatively, the suspension medium comprises a water-based substance, such as water and a thickener and/or dispersant.

Electrodes 18 can be coated using coating suspensions having more than 70 weight % alkaline earth carbonate content and up to 85 weight % alkaline earth carbonate content. However, in order to accomplish these greater than conventional weights of alkaline earth carbonate content on the electrodes, it may be desirable to employ a bimodal particle size distribution of alkaline earth carbonates in the coating suspension.

As used herein, a bimodal suspension of alkaline earth carbonates can be composed of two groups of particles of the same chemical composition. Alternatively, the required mixing ratio of three alkaline earth carbonates can be achieved by blending two—one coarse and one finer sized—fractions of different composition. An example of the latter would be if 10 w % CaCO₃ is used in the mixture, it can constitute the finer fraction alone and in this case the coarse fraction is made up of SrCO₃ and/or BaCO₃. However, each separated group is distinguished by the distribution of the sizes of the particles in that group, and that characterizing size is termed the maximum of the volume distribution of that group. As noted above, the size distribution of these powders of alkaline earth carbonates is generally of log-normal type, i.e., the histogram is symmetrical around the mode above a logarithmic horizontal axis. In the distribution of particles depicted in FIG. 4 for example, the maximum of the volume distribution of that group of particles is identified by a LOG 10 micrometer diameter of 0.3 (which is close to 2 micrometers), and in the distribution of particles depicted in FIG. 6 for example, the maximum of the volume distribution of that group of particles is identified by a LOG 10 micrometer diameter of 0.6 (which is close to 4 micrometers).

Moreover, in accordance with an example of the present invention, one group of such particles is distributed about the modal particle size (i.e., maximum) that is much smaller than the modal particle size (maximum) about which the other group of particles is distributed. When the modal particle size of the distribution of particles is expressed by the diameter measured in units of micrometers, the difference in modal particle size desirably is at least a factor of two and as much as a factor of ten. Thus, in units of micrometers the size belonging to one of the maxima in the bimodal distribution is at least twice the size belonging to the other maximum and can be as much as ten times the maximum of the other group of particles. Moreover, the group of particles of the smaller size diameter (smaller maximum) desirably can constitute from ten volume (weight) percent of the alkaline earth carbonates in the suspension to forty percent (40%) of the alkaline earth carbonates in the suspension. In other words, the group of particles of the larger size diameter (larger maximum) desirably can constitute from sixty percent (60%) of the alkaline earth carbonates in the suspension to ninety percent (90%) of the alkaline earth carbonates in the suspension.

In accordance with embodiments of the present invention, anywhere from 10 weight % to 40 weight % of the carbonates in a conventional suspension for coating electrodes with emission material is replaced by alkaline earth carbonates of the same (or different) chemical composition but having one half to one tenth of the modal particle size of the remaining 90 weight % to 60 weight % of the alkaline earth carbonates. Thus, 10 weight % to 40 weight % of the alkaline earth carbonates in the coating suspension of embodiments of the present invention desirably contain particles of modal size in the 0.3 micrometer to 5 micrometer range and have the particle size distribution by volume with the smaller of the two modes (maxima).

At one extreme of the range of bimodal particle groupings in the bimodal suspension according to an embodiment of the present invention, the modal size disparity between the larger and smaller particles is at a maximum, and the smaller particles constitute the smallest proportion of the alkaline earth carbonates in the allowable range of ten (10) weight percent (%) to forty (40) weight percent (%). These relatively smaller particles (one tenth the modal size) in the overall bimodal particle size distribution make up the smallest percentage (10%) presence of the alkaline earth carbonates in the bimodal suspension. In each such embodiment, the larger maximum is ten times the smaller maximum, and thus the average particle size distribution of one of the two maxima is no more than one tenth of the average particle size distribution of the other maximum. For example, one maximum could be at 0.3 micrometers and the other maximum could be at 3.0 micrometers. In another similar example of this same extreme of the range of bimodal particle groupings, but for particles ranging in modal size up to 10.0 micrometers, the maximum with the smaller percentage (10%) presence could be at 1.0 micrometer and the other maximum with the larger percentage (90%) presence could be at 10.0 micrometers.

At the opposite extreme of the range of bimodal particle groupings in the bimodal suspension according to an embodiment of the present invention, the size disparity between the larger and smaller particles is at a minimum, and the smaller particles constitute the maximum allowable proportion of the alkaline earth carbonates in the allowable range of ten (10) weight percent (%) to forty (40) weight percent (%). Thus, the proportion of the larger particles in the bimodal suspension is only 60% of the total instead of the 90% presence of the larger particles as described above. In this opposite extreme condition, the larger maximum is only twice the smaller maximum, and the grouping of particles with the larger maximum constitutes only 60 percent of the alkaline earth carbonates in the bimodal suspension. In one such example, these particles thus can range in size up to 3.0 micrometers, wherein the modal particle size of the alkaline earth carbonates constituting 60 weight % of the suspension is 3 micrometers, and 40 weight % of the alkaline earth carbonates in the bimodal suspension according to an embodiment of the present invention has a modal particle size of 1.5 micrometers. Thus, one of the two maxima is at a particle size that is no more than half of the modal particle size of the other maximum. In another similar example for particles ranging in modal size up to 10 micrometers, the bimodal suspension of alkaline earth carbonates has the smaller maximum (mode) at 5 micrometers and the larger maximum at 10 micrometers. However, the presence of the relatively smaller particles (one half the size) in the overall bimodal particle size distribution is only one ninth of the presence of the relatively larger particles. In a further similar example for particles ranging in modal size up to 10 micrometers, the bimodal suspension of alkaline earth carbonates has the smaller maximum (mode) at 3 micrometers and the larger maximum at 10 micrometers. However, the presence of the relatively smaller particles (less than one half the size) in the overall bimodal particle size distribution is only two thirds of the presence of the relatively larger particles (a 40% to 60% proportionate presence).

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

It is to be understood that the ranges and limits mentioned herein include all sub-ranges located within the prescribed limits, inclusive of the limits themselves unless otherwise stated. For instance, a range from 100 to 200 also includes all possible sub-ranges, examples of which are from 100 to 150, 170 to 190, 153 to 162, 145.3 to 149.6, and 187 to 200. Further, a limit of up to 7 also includes a limit of up to 5, up to 3, and up to 4.5, as well as all sub-ranges within the limit, such as from about 0 to 5, which includes 0 and includes 5 and from 5.2 to 7, which includes 5.2 and includes 7.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A method for making a light source that includes a substantially transparent envelope having an inner surface coated with a layer including a phosphor composition, the method comprising:
installing in the envelope at least one electrode coated with an emission mix material, wherein the at least one electrode coated with an emission mix material has been prepared by coating an electrode with a suspension comprising more than about 70 weight % alkaline earth carbonate content;
evacuating the envelope; and
adding into the evacuated envelope and confining within the envelope, a first amount of mercury and a second amount of an inert gas to produce the light source.

2. The method of claim 1, wherein the suspension comprises particles having two differently sized parent distributions such that the particles comprise two different modal particle size distributions by volume.

3. The method of claim 2, wherein the suspension has a bimodal particle size distribution by volume.

4. The method of claim 1, wherein the suspension comprises particles having a bimodal particle size distribution by volume with two maxima and with one of the two maxima being at a particle size that is no more than half of the particle size of the other maximum.

5. The method of claim 4, wherein the particle size of one of the maxima of the volume distribution is between one half and one tenth of the particle size belonging to the other maximum.

6. The method of claim 4, wherein 10 weight % to 40 weight % of the particles comprise an average particle size distribution with the smaller of the two maxima.

7. The method of claim 4, wherein the particle size belonging to one of the two maxima of the particle distribution by volume is no more than one tenth of the particle size of the other maximum.

8. The method of claim 1, wherein the suspension has a particle size distribution by volume with two maxima and with one of the two maxima being at a particle size that is no more than one tenth of the particle size of the other maximum.

9. The method of claim 8, wherein 10 weight % to 40 weight % of the particles have the particle size with the smaller of the two maxima.

10. The method of claim 1, wherein no more than 60 weight % of the particles in the suspension have a modal particle size in the 3 micrometer to 10 micrometer range.

11. The method of claim 1, wherein more than 10 weight % of the particles in the suspension have a modal particle size in the 0.3 micrometer to 5 micrometer range.

12. A mercury vapor discharge fluorescent lamp, comprising:
a sealed, light-transmissive envelope having an inner surface defining an interior volume of the envelope;
an electrode structure disposed within the interior volume of the envelope and configured for providing a discharge within the interior volume of the envelope; and
a fill gas comprising mercury and an inert gas sealed inside the envelope;
wherein the electrode structure comprises a coating layer of emission mix material which has been prepared by coating an electrode with a suspension comprising more than about 70 weight % alkaline earth carbonate content.

13. The fluorescent lamp of claim 12, wherein the suspension comprises more than 80 weight % alkaline earth carbonate content.

14. The fluorescent lamp of claim 12, wherein the suspension comprises particles having a bimodal particle distribution by volume.

15. The fluorescent lamp of claim 14, wherein the particles have a particle size distribution by volume with two maxima and with one of the two maxima being at a particle size that is no more than half of the particle size of the other maximum.

16. The fluorescent lamp of claim 15, wherein 10 weight % to 40 weight % of the particles in the suspension has the smaller of the two maxima.

17. The fluorescent lamp of claim 16, wherein the smaller of the two maxima is no more than one tenth the larger maximum.

18. The fluorescent lamp of claim 16, wherein particles in the suspension having the smaller of the two maxima has a maximum in the range of 0.3 micrometers to 5 micrometers.

19. A method for making an electrode coated with an emission mix material, the method comprising:
coating an electrode with a suspension comprising more than about 70 weight % alkaline earth carbonate content to form a coated electrode;
optionally drying the coated electrode to form a dried electrode; and
activating the dried electrode to form an electrode coated with an emission mix material.

20. The method of claim 19 wherein the suspension comprises particles having two differently sized parent distributions such that particles comprise two different modal particle size distributions by volume.
